(19) United States
(12) Patent Application Publication
(10) Pub. No.: US 2012/0016961 A1
(43) Pub. Date: Jan. 19, 2012

(54) SHORT-RANGE COMMUNICATION-ENABLED MOBILE DEVICE, METHOD AND RELATED SERVER ARRANGEMENT

(75) Inventor: Tuomo Tuikka, Oulu (FI)

(73) Assignee: SOLOCEM SYSTEMS OY, Kempele (FI)

(21) Appl. No.: 13/260,620

(22) PCT Filed: Apr. 9, 2010
(86) PCT No.: PCT/FI2010/050286

§ 371 Date: Sep. 27, 2011

(30) Foreign Application Priority Data
Apr. 9, 2009 (FI) 20095402

(51) Int. Cl. G06F 15/16; H04W 4/02

(52) U.S. Cl. 709/217

(57) ABSTRACT

A mobile device includes a processor and memory for processing and storing data, respectively, a wireless transceiver for wirelessly transmitting and receiving data relative to remote devices, a short-range wireless transceiver for wirelessly cooperating with a remote device equipped with a compatible short-range transmitter or transceiver, a virtual context detection logic configured to obtain, via the short-range wireless transceiver, data distinctive to and provided by a tag disposed in a location accessible by a user of the mobile communications device in the light of the range of short-range data transfer, the distinctive data being indicative of the virtual context, and a virtual context notification logic configured to transmit an indication of the virtual context to a remote entity, via the wireless transceiver so as to enable the remote entity, or a further entity connected thereto, to represent the user in a virtual environment according to the virtual context. A related server arrangement and method are presented.

### FIELD OF THE INVENTION

Generally the invention relates to short-range communication such as near field communication (NFC). In particular, the invention concerns provision of virtual context information via the short-range communication.

### BACKGROUND

Communication falling under NFC typically refers to short-range wireless, i.e. contactless, communication following the corresponding standard(s) aimed for simple and safe communication between electronic devices. NFC communication is enabled by bringing two NFC compatible devices within a short distance, e.g. few centimeters, of one another. Contemporary applications of NFC technology are associated with different financial transactions, such as various payment and ticketing services, and simple data access, e.g. data retrieval, solutions. NFC capability may be added to a mobile terminal, a PDA (personal digital assistant), or some other portable or even hand-held device, which can be, and often is, carried along anyway. Technology-wise NFC is typically based on inductive-coupling, which reminds of the technology behind RFID (RF identification) identification tags and transponders. NFC technology is specified in a plurality of standards relative to the applicable hardware components and used data transfer methods. Standards are created, maintained and/or adopted by entities including, but not limiting to, ISO/IEC (International Organization for Standardization/International Electrotechnical Commission), ETSI (European Telecommunications Standards Institute), ECMA (European association for standardizing information and communication systems), GSMA (GSM Association), The Wireless USB Promoter Group and Wi-Fi Alliance. Large conglomerates such as Philips and Sony (e.g. FeliCa) have been active in developing NFC capable devices.

Social media applications such as Facebook, MySpace and LinkedIn have gained tremendous popularity among the Internet users since the beginning of the 2000's. The concept of establishing various online communities through creation of an up-to-date on-line user profile by a desktop or portable computing device in a preferred social networking service and subsequently inviting a number of friends or business contacts to join the service for future information sharing seems to be the most typical implementation approach depending on the focus of the service (either business-oriented or a more like a buddy list). The users belonging to the same sub-community, i.e. ‘friends’ or ‘contacts’, may often contribute to others' profiles and share thoughts, files, links, and applications via the service whereas the remaining users being not members of the same sub-community may only access limited information. The social networking solutions thus try to combine features from more traditional paper-form or electronic personal address book, calendar, blogs, and web pages into an aggregate (social) life portal for also others to use.

Also different virtual world hangouts, such as Habbo Hotel and Club Penguin, which approximate virtual reality, have recently popped up in addition to the afore-explained social networking applications. In a virtual hangout, the users may be represented by avatars that are capable of moving and acting in the given virtual environment including communication with other users.

### SUMMARY OF THE INVENTION

The objective is to enhance context awareness in connection with various arrangements bearing the aspect of short-range wireless communication, such as different arrangements incorporating the features of a virtual environment and/or social networking.

The objective is achieved by means of a mobile communications device, a system and a method in accordance with the present invention enabling linking physical context, such as a physical space, with virtual context, such as a virtual space, via utilization of short-range wireless communication taking place between a mobile communications device and a remote device such as a tag providing at least part of the information for performing the linkage. The tag is, as a physical object, disposed in a physical space, such as a room or other location, whereupon the information provided by the tag to the close mobile communications device is locally, at the mobile communications device, or remotely, e.g. in a remote server provided with data from the mobile communications device, mapped to virtual context information, such as a virtual room or other location in a virtual environment. A user of the mobile communications device may be represented, e.g. via an avatar, in that virtual context of the virtual environment. The virtual environment may be included in a social networking solution incorporating a virtual hangout feature, for example. The tags are advantageously (re)programmable to provide the desired information during the short-range wireless communication. Alternatively, pre-coded tags may be used and disposed so as to properly reflect the meaning of pre-coded data.

Accordingly, in an aspect of the present invention a mobile communications device comprises a processor and memory for processing and storing data, respectively, a wireless transceiver for wirelessly transmitting and receiving data relative to a remote device, a short-range wireless transceiver, such as an NFC transceiver, for wirelessly co-operating with a remote device equipped with a compatible short-range transmitter or transceiver, such as a tag, the device further comprising
a virtual context detection logic configured to obtain, via the short-range wireless transceiver, data distinctive to and provided by a tag disposed in a location accessible by the user of the mobile communications device in the light of the range of short-range data transfer, said distinctive data being indicative of the virtual context, and
a virtual context notification logic configured to transmit an indication of the virtual context, such as at least part of said obtained data, to a remote entity, such as a server or some other mobile communications device, via the wireless transceiver so as to enable the remote entity, or a further entity connected thereto, to represent the user in a virtual environment according to the virtual context.

In addition to or instead of the wireless transceiver, the virtual context notification logic may be enabled to utilize a wired interface or the short-range wireless transceiver for transferring context indications to a remote device, such as a personal computer, for storage, analysis and/or forwarding purposes.

In one embodiment the virtual context may refer to a virtual location and/or virtual space, such as a virtual building or a room thereof in a virtual environment created by a virtual hangout system such as the aforesaid Habbo. The data associated with and provided by the tag may include explicit definition of the virtual context (e.g. context ID), or the data may be just indirectly indicative of the context, i.e. the mobile communications device or a further device obtaining the data therefrom shall map the data obtained from the tag to a virtual context on the basis of locally available mapping information, e.g. a mapping logic such as a mapping table. Thereby, in the latter case, in one further, either alternative or supplementary, embodiment an arrangement comprising the mobile communications device further comprises at least one entity, such as a server entity, which is configured to determine the virtual context on the basis of such indirect information received from the mobile device.

In one, either alternative or supplementary, embodiment the data provided by the tag may link to different virtual contexts depending on the particular user/mobile communications device accessing the data. The mobile communications device or some other device, such as a server, may include device/user-specific tag data-to-virtual context mapping information.

In one, either alternative or supplementary, embodiment the mobile communications device may be further configured to acquire and/or transmit (real) status information relative to the user of the device. The status information may be applied to control the representation, such as an avatar, of the user or related information in the virtual context, e.g. the type, size, color, gesture, and/or movements of the representation. The status information may be thus indicated in a desired manner in the virtual domain. The status information may be generated by the mobile communications device automatically on the basis of sensing functionalities (e.g. software and/or hw sensor probes) and/or manually by the users (e.g. profile change, status indicator adjustment, etc.).

In another aspect, a server arrangement for controlling a virtual environment, such as a virtual hangout system of a number of users, comprises a processor for processing data, a memory for storing data, and a communications interface for transferring data via a communications network, the server arrangement further comprising
a virtual context acquisition logic for obtaining, via the communications interface, a virtual context indication relative to a user of the virtual environment, said indication being based on data distinctive to and provided by a tag disposed in a location accessible by the user with a short-range wireless transceiver of a mobile communications device, said distinctive data being indicative of the virtual context associated with the tag, and
a virtual environment management logic for adapting the virtual representation of the user, such as an avatar, according to the virtual context in the virtual environment.

For example, if the virtual context defines a virtual location/space, the representation may be located in that space. Alternatively or additionally, provided that the virtual context defines some virtual action (e.g. jumping around), the virtual representation may be adapted to perform that action. As a further option, the virtual context may refer to virtual status, such as virtual mental and/or virtual physical status, of the user instead of the real status of the user, which may also be provided for controlling the virtual representation as described hereinbefore.

The system to be controlled by the server arrangement may be implemented by the arrangement itself, e.g. a network service/application running in the arrangement for remote users, or by a an external entity, such as a further server, whereto the server arrangement provides data such as virtual environment management instructions based on the acquired virtual context indications.

The server arrangement may further be configured to receive social contact information, such as social contact registrations, from the mobile communications devices via the communications network.

The mobile communications device comprises a short-range wireless transceiver, such as a near field communication (NFC) transceiver targeted towards peer-to-peer radio link-type communication. The device further comprises at least one supplementary wireless communications adapter, which preferably supports longer range and/or higher data rates than the short-range transceiver. Non-limiting examples of the further adapters include a GSM (Global System for Mobile Communications) transceiver, a GPRS (General Packet Radio Service) transceiver, an EDGE (Enhanced Data rates for Global Evolution) transceiver, a UMTS (Universal Mobile Telecommunications System) transceiver, a WCDMA (wideband code division multiple access) transceiver, a PDC (Personal Digital Cellular) transceiver, a PHS (Personal Handy-phone System) transceiver, and a WLAN (Wireless LAN, wireless local area network) transceiver. The adapter may be such that it is configured to cooperate with a predetermined communications network (infrastructure) such as the adapters listed above. The network may further connect to other networks and provide versatile switching means for establishing circuit switched and/or packet switched connections between the two end points. In addition/alternatively the device may comprise a supplementary wireless adapter such as a Bluetooth adapter meant for peer-to-peer communication and piconet/scatternet use. In addition, the device may comprise interface(s) for wired connections and associated communication relative to external entities, such as an USB (Universal Serial Bus) interface, Ethernet interface, or Firewire interface.

The mobile communications device may be brought, by the user thereof, into the vicinity, i.e. within the range of the short-range wireless transmitter/transceiver of the tag so that the mobile communications device may receive data, such as an indication of the virtual context, transmitted by the tag over the established peer-to-peer (P2P) connection. Additionally, in the case of a connection with other mobile communications device of a second user, a record of the associated ‘ad hoc’ social contact and bond between the users may be obtained (the other device may create substantially a similar record).

The mobile communications device may wirelessly address and send virtual context notifications to remote entities, such as servers other mobile communications devices. In the case of a server representing the remote entity, access to the received indication of the detected virtual context of a mobile communications device (and user thereof) may be provided to the social contact of the device owner by forwarding the indication itself either as is or in a modified form, and/or by providing access to the server. In another scenario, the mobile communications device addresses the context indication directly to another mobile communications device, e.g. a device of a social contact, whereby the indication may be transmitted thereto locally over a peer-to-peer-connection between the devices or via intermediate devices such as a network infrastructure taking care of the routing procedure. In either case, the remote entity may send the indication further to another at least one entity, which may then forward the information to the end user or provide at least access thereto.

Both the virtual context detection process and the virtual context itself are inherently physical location-based as the virtual context is detected and notified as a result of (wireless) interaction of a physical tag disposed in some physical location with a mobile communications device. Preferably the data provided by a single tag is made unique, i.e. there are no tags providing completely identical data to reader devices, not at least within the same potential user group. If several tags provide exactly similar data, the obtainable context resolution naturally decreases and associated level of uncertainty increases (which may be occasionally desired though).

The data provided by the tags may include virtual context data, geographical location-related data such as exact position information in a form of coordinates, or more blurred, implicit or relative location-related data such as status and/or event indicators (home, work, car, conference, meeting, busy, skiing, party, etc.)

The used data format shall preferably follow a predetermined syntax. The data format may support numerical and/or textual information, e.g. a free text field. The virtual context may be indicated via a separate field or with the free text field, for example. Free text field may include expressions like “Virtual hangout X: virtual space Y”, which associates the tag with the virtual environment X and, more specifically virtual space Y therein, whereto the virtual representation of the user may be then located. Further, the data format may include a tag ID field. The provided data may specifically indicate, e.g. via a predetermined code, that the tag is particularly intended for use with the present invention as various tags for various different purposes may be generally located in the environment accessible by the users of the present invention.

Yet, in addition to the short-range communication means, such as the NFC transmitter/transceiver, the tag may carry a communications transceiver, a wireless and/or wired one, for communicating with the mobile communications device or other entities, such as a server, through a communications technology different from the short-range NFC or corresponding technique, optionally advantageously providing a benefit over the NFC e.g. via higher bandwidth and/or greater range. In one embodiment, after initial interaction between the mobile communications device and the tag to occur using NFC or some other feasible wireless short-range technology, further data transfer takes place using the additional transceiver following some other wireless communications technique, e.g. WLAN or Bluetooth, also supported by the mobile device. The tag may obtain ID information from the mobile communications device and provide it together with virtual context data forward to a server instead of or in addition to the mobile communications device.

Despite the fact that the mobile communications devices and compatible tags may, as being physically separate or at least separable devices, be either occasionally or most of the time situated far away from each other, the devices shall be brought within sufficiently close mutual distance, i.e. within range of the applied wireless short-range communications technology utilized by the devices, e.g. the NFC, when the virtual context detection feature of the present invention is to be actualized. The applicable range of e.g. NFC communication may typically differ from about direct physical contact between the devices (in which case the distance between the NFC transmitters, receivers, and/or transceivers embedded in the housings of the devices may still be greater than zero, e.g. few centimeters) to tens of centimeters or more, e.g. few meters.

Structural and/or functional elements of the mobile communications device, such as the processor, the memory, the transceivers, and the different logics, are at least functionally connected together either directly or via intermediate elements in order to provide the necessary execution, storage, control, detecting, analysis, notification and data transfer capabilities for implementing the invention. The above and other features may be integrated with the device or provided as connectable accessories or modules.

In view of the foregoing, in a further aspect of the present invention, a system for enhancing context awareness in social networking comprises
a number of tags to be disposed in a number of locations, respectively, each tag comprising a short-range wireless transmitter for transmitting data distinctive to and stored by the tag, and
the mobile communications device and/or the server arrangement as described herein.

Still, the system may comprise a number of further remote entities such as servers for storing and utilizing the virtual context data and optionally social contact data.

Yet, in a further aspect a method for enhancing context awareness in applications incorporating a virtual environment feature, comprises
obtaining indication of a virtual context of a user of a mobile communications device, said indication being based on data provided by a short-range wireless communications tag to the mobile communications device, and
adapting a virtual representation of the user in the virtual environment according to the virtual context.

The method may further comprise obtaining a number of tags comprising a short-range wireless transmitter for transmitting data distinctive to and stored by the tag, and disposing the tags in a number of locations respectively. The data may be fixedly (e.g. by the factory or by retailer) pre-programmed or user-editable via the short-range connection, for example. Editability may be provided, e.g. upon a tag purchase, via a password/code and/or some other authentication method, which are optionally user adjustable. The data may also comprise dynamic data such as real-time data from the attached sensor(s) or other elements at least functionally connected to the tag.

The utility of the present invention arises from a plurality of issues. The devised solution enables linking a physical tag with a virtual context such as a certain virtual space. Thus in addition to or instead of utilizing short-range wireless communication tags for registering a physical context, e.g. location, of users in various systems (which may be done as well), the virtual context of the users may be updated. Likewise, the tags distributed in the environment provide for virtual context updates arising from tag contacts without additional hassle relating to manual virtual context switching via the mobile device etc. The invention may utilize the Internet as information distribution medium, but is not dependent on web or web-based UI's like most prior art social networking solutions.

The expression “a number of” refers herein to any positive integer starting from one (1), e.g. one, two, or three.

The expression “a plurality of” refers herein to any positive integer starting from two (2), e.g. two, three, or four.

The expression “tag” refers herein to an electronic device capable of transmitting data stored therein to the mobile communications device via a compatible short-range data transfer technology such as the NFC. The tag may comprise further interfaces and elements. It shall be construed as a functional modifier despite of the particular official appellation of any element acting as a tag in the meaning of the present invention.

Different embodiments of the present invention are disclosed in the dependent claims.

### BRIEF DESCRIPTION OF THE RELATED DRAWINGS

Next the invention is described in more detail with reference to the appended drawings in which

FIG. 1 illustrates one embodiment in accordance with the present invention.

FIG. 2 is an illustration of mobile communication device internals according to an embodiment of the present invention and its connectivity towards remote entities such as one or more network servers.

FIG. 3 is a flow diagram of an embodiment of a method according to the present invention.

### DETAILED DESCRIPTION OF THE EMBODIMENTS

Reverting to the foregoing, a number of tags may be acquired and subsequently coded and disposed in various locations to enable virtual context awareness feature of the present invention.

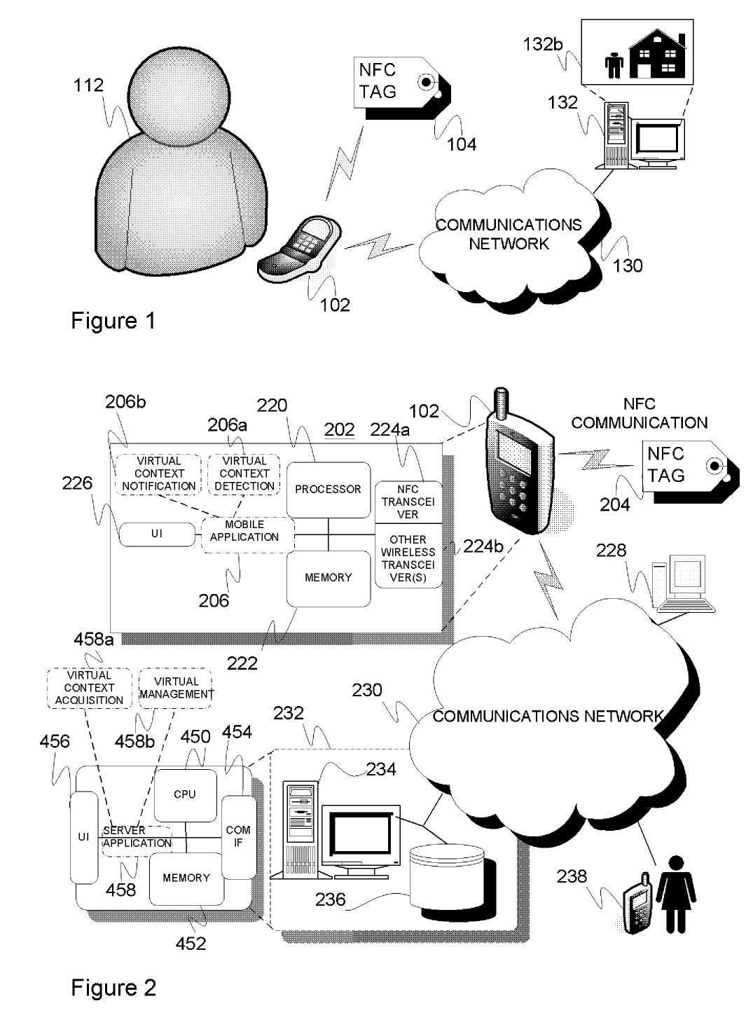

FIG. 1 illustrates one embodiment according to the present invention. A user 112 has a mobile communications device 102, hereinafter ‘mobile device’, of one's own provided with necessary software, e.g. an application, for implementing at least part of the present invention. The mobile device 102 receives data from a near-by NFC tag 104 including data indicative of the virtual context associated with the tag 104. The mobile device 102 sends an indication of the virtual context and necessary other information (e.g. a user ID to identify the user in question) towards a remote entity such as one or more servers 132 residing in communications network(s) 130. The server 132 may utilize the received virtual context information to locate a virtual representation of the user 112 in a virtual world according to the context. In the shown, merely exemplary, screenshot 132b, the virtual representation of the user 112 is located next to a virtual building of the virtual world, as alluded by the indication of the virtual context (e.g. “virtual context is the front garden of building X”).

Similarly, an indication of the physical context (e.g. real-world location) of the mobile device 102 and thus the user thereof may be obtained through short-range wireless communication with the tag 104 (the output data of which being indicative of the physical context) and forwarded to one or more remote entities.

The short-range wireless communication may be also applied in creating new social contacts. The user 112 may have activated a feature allowing establishment of new contacts via the supported short-range wireless technology such as NFC. Then the user 112 meets another user with a correspondingly enabled mobile device, and the users decide to add each other as a new social contact. The mobile devices 102 are set next to each other, whereupon social contact registration logics in both devices mutually exchange information. Consequently, a mobile viral social network associated with either user 112, 114 and his/her mobile device 102 is expanded. From a technical standpoint one device may act as a master and the other as a slave during the communication, for example. The exchanged information may be delimited to the personal information and/or mobile device information of the users 112, 114 themselves, or data on already-existing other social contacts may be optionally transferred to a predetermined extent (e.g. mere names, aliases or other ID's) as well.

Mobile devices 102 may forward the obtained information, by means of social contact notification logic, to remote entities such as the server 132, which may further distribute at least part of the information. After registering the social contact a virtual/physical context update relative to either device 102 (and implicitly user 112, 114) may be obtained by the other device 102 (and user 112, 114), respectively, through receiving a context notification sent by the remote entity such as the server 132, or by directly accessing the service. Alternatively, the context update may be provided by a further entity such as a web-based social networking and/or a virtual environment (˜virtual world) service, which receives context updates from the remote entity.

In one more embodiment of the present invention, which may be implemented with physical context and/or virtual context features, a service toolbox may be offered to service providers, such as event organizers, preferably including a server to be contacted, by a mobile device of a service user and/or a service-related tag upon short-range wireless communication taking place between the mobile device and the tag, and a number of tools for specifying the nature of the service/event and optionally the associated web service (for the service provider and/or the users), managing the associated service/event, producing (output) data for the associated tags (e.g. context data and/or a link to a network server), and/or coding of tags with the data among possible other tools. The server may be a service/event-specific server communicating with a more general server, such as the social contact and/or context management server (capable of registering a social contact between the users of two mobile devices on the basis of short-range data transfer between the two/capable of maintaining context information based on mobile device-tag interaction, respectively), or integrated with the latter. The service toolbox may provide valuable information (‘added value’) such as user names, number of simultaneous users/users present in the event, user's social network details such as size, etc. to the service provider/event organizer. The information may be received from the more general server, for example. The toolbox may include software and optionally hardware, such as the aforesaid dedicated server. A related software application may also be provided for the mobile devices. Preferably the toolbox includes a graphical UI, e.g. a browser-based UI, for the service providers.

The toolbox may also offer a UI for the users of the (event) service to obtain information on the social contacts and the event/service itself, and optionally for managing the related information. The toolbox preferably applies interfaces generally designed for different types of events in view of associated communication and e.g. gaming. The service provider and/or the users may launch event-related actions, such as games, and monitor the results thereof via the toolbox. A documentation (management) system may be coupled to the server such that documents and/or links to the documents associated with the service are available e.g. through the tags, i.e. interaction with a tag through a mobile device may trigger data transfer of the link/document to the mobile device, for example. The events may be recreational events, parties, (scientific) conferences etc.

For instance, by utilizing the service toolbox a service provider, like a bar or shop owner, or event organizer, is able to define in advance e.g. the material, like an offer, an advertisement, or an invitation, to a competition, that is to be sent to the user 112 when certain one or more predetermined conditions e.g. in the status of the user or a group of users, and/or of a location, are met.

Material such as an offer may be sent by an embodiment of the aforesaid server arrangement to a number of users, e.g. substantially all the users, in a certain location, like a bar, at a specific time instant. Similarly, an offer and/or other material may be sent to one or more, e.g. all, members of a group of users, if they belong to a same social or professional network group, for example, i.e. are connected to each other as friends and/or business contacts, and preferably if they are located in a same location, like a bar, and optionally if the total number of members in that specific location exceeds a predefined limit, like for instance when five or more users are present. Additionally, if a user makes a new friend or professional connection in a location, such as a bar, congratulation or other related message may be sent to him/her by the server arrangement.

Each material delivery, such as an offer, may be attached with an identification number, that may be used by the service toolbox or some other system that the service provider, like a bar, applies, for controlling the use of the material, like if an offer is accepted and claimed.

Thus the server arrangement, toolbox and/or some other integrated or stand-alone entity, such as a control mechanism or logic, or an associated control entity, may be provided for transmitting material conditionally to the users. The entity may be arranged to utilize context information and/or predetermined configuration information for determining and/or selecting the material itself and/or the transmission instant thereof. The context information may relate to virtual and/or physical context.

In a further, either supplementary or alternative, embodiment, an application running in a server (accessible via a web browser or a dedicated application using a terminal device, for example) and/or in a mobile device (e.g. server master vs. terminal client), may be arranged to provide a preferably graphical UI (user interface) that enables easy registration to the local server (/service) or other servers (/services) by applying user, social contact and/or context information already maintained by any of the servers. The registration may at least be triggered visually, i.e. a symbol representing a user of the UI may be drag-and-dropped or copy-pasted by the user onto an area associated with a target server (/service), such as a social networking and/or virtual environment service. After such action, the registration to the target server (/service) is preferably initiated automatically. Alternatively, the area may be, for example, double-clicked for initiating the registration. In one use scenario, the available user information (e.g. personal information and social contacts information) is automatically transmitted from the data maintenance server (/service) to the target server (/service) so that the amount of manual registration work (e.g. manual typing of remaining obligatory user data) is minimized. Information may also be prompted from the user by the target server (/service), e.g. via a browser window opened in response to the registration initiation and linked with the target server (/service). The UI may represent a number of servers (/services) via characterizing graphical symbols and/or text, for example. The UI may also visualize social contacts of the user and their possible registrations to the servers (/services). The provided arrangement facilitates integration and data transfer between different social media systems, for example. The application may transfer data between the mobile device and the servers (/services).

FIG. 2 is an illustration of internals 202 of a mobile device 102 according to an embodiment of the present invention and its connectivity towards remote entities such as a network server 232, 228, a tag 204, a mobile device 238, etc. The mobile device 102, such as a mobile terminal, a smart phone, or a PDA (personal digital assistant) has been provided with a short-range wireless transceiver such as an NFC transceiver or ‘NFC reader’ and software, e.g. a virtual context application and optional social contacts manager application, providing necessary logics for virtual context detection/notification and optionally social contact registration in addition to further possible tasks.

Short-range connection establishment and/or data transfer may generally follow e.g. the existing NFC standards and they may be adapted or supplemented by additional software and/or hardware such that a required level of automation and desired spectrum of features is obtained for the NFC functionality. The transfer may be initiated in response to detecting a triggering condition. The overall NFC communication process between two devices may also be executed in multiple subsequent steps, wherein the communication is first generally started between the devices during which the fulfillment of one or more conditions defines whether the communication process really ever proceeds to a stage associated with the transfer of NFC data in accordance with the present invention. The conditions may be checked by a predetermined negotiation and/or hand-shaking scenario in which the devices exchange information related to the existence of the NFC functionality and/or device/user identities, for example. As one implementation, data transfer can be made conditional also on factors such as the identity of the remote device and/or device user in addition to mere technological and spatial connectivity and compatibility. Additionally or alternatively, the devices may verify the fulfillment of other conditions for NFC data transfer. In the case of basic tags, those may, after being powered up by the electromagnetic field introduced by the mobile device 102, just send data thereof to the device 102 for triggering a virtual context update and possible other functions.

The embodiment 202 of the mobile device 102 in accordance with the present invention comprises at least one processor 220 such as one or more microprocessors, micro-controllers, DSP's (digital signal processor), programmable logic chips, etc. The processor 220 may comprise a plurality of co-operating processors or sub-processors. The processor 220 is configured to execute the code stored in a memory 222, which may imply processing instructions and data relative to the application(s) 206. There may be memory areas for data elements such as virtual context data element(s), optional mappings, optional social contact information, and optional other elements. The application(s) 206 may utilize a dedicated or a shared processor for executing the tasks thereof. The memory 222 may be divided between one or more physical memory chips or other memory elements. The memory 222 may further refer to and include other storage media such as a preferably detachable memory card, a floppy disc, a CD-ROM, or a fixed storage medium such as a hard drive. The memory 222 may be non-volatile, e.g. ROM, and/or volatile, e.g. RAM, by nature.

The UI (user interface) 226 may comprise a display, and/or a connector to an external display or data projector, and keyboard/keypad or other applicable control input means (e.g. touch screen or voice control input, or separate keys/buttons/knobs) configured so as to provide the user of the device 202 with practicable data visualization and device control means. The UI 226 may include one or more loudspeakers and associated circuitry such as D/A converter(s) for sound output. In addition, the device 202 comprises a radio part including a wireless transceiver 224b (e.g. GSM, UMTS, WLAN) for general communications with other devices and/or a network infrastructure, and a short-range wireless transceiver 224a, such as an NFC transceiver, for close-proximity communication with other mobile devices and/or tags, and optional other wireless or wired data connectivity means such as one or more radio transceivers or wired interfaces (e.g. Firewire or USB) for communication with other devices such as terminal devices, peripheral devices or network infrastructure(s). It is clear to a skilled person that the device 202 may in practice comprise numerous further functional and/or structural elements for providing various beneficial communication, processing or other features, whereupon this disclosure is not to be construed as limiting the presence of potential additional elements in any manner.

As mentioned above, the software 206 functionality may be implemented as one or several, mutually communicating, software applications executed by the processor 220. This computer software (product) may be thus provided on a carrier medium such as a memory card, a memory stick, an optical disc (e.g. CD-ROM or DVD), or some other memory carrier. The instructions required for implementing the application(s) may be stored in the carrier medium as executable or in some other, e.g. compressed, format, such that the software may be transported via the carrier medium to a target device and installed therein, e.g. in the hard disk thereof, or executed directly from the carrier medium in the target device by loading the related instructions to the memory 222 of the target device not until execution, for instance.

The tag 204 similarly comprises (not shown) at least a memory, a processing unit and a short-range transmitter or transceiver for storing and providing data to a nearby mobile device 102, 202. The tag 204 may have a further connectivity means, wired and/or wireless, for communicating with mobile devices 204 or other entities like the network infrastructure 230.

A remote entity 232, such as a server 234, comprises a memory 452 including e.g. a database 236, a processor 450 and at least one, wired or wireless communications interface 454, for communicating, via a network infrastructure, with a number of mobile devices 102 and optional further entities 228. Advantageously the server 234 comprises at least part of the virtual context information and optionally social contact information available in and/or obtained via the mobile devices 102 of the service users, optionally even more information, and receives at least part of the virtual context indications for controlling the virtual environment and/or providing other terminal devices (and thus the users thereof) and/or further entities with related notifications. Software 458 such as one or more service management applications may be applied to control the operation of the server 234 as desired via social contact and/or context management logics, for instance. Physically the server 234 may consist of one or several at least functionally interconnected devices, e.g. function-specific servers. UI 456 may be provided for administration purposes.

The mobile device 102 may preferably communicate with a communications network 230, herein referring to one or more coupled networks, via the wireless transceiver provided in addition to the short-range wireless transceiver. A remote entity 232, such as the server 234 and database thereof 236, may be functionally connected to the network 230 as well. The server 234 may directly implement a system for end-users and/or it may act as a controller/virtual context (and optionally social contact) data source for entities 228, e.g. servers, of external service providers such as virtual environment/social networking services.

The server 232 may transmit (push, for example) information to further entities 228, or the further entities 228 may poll the remote entity 232, i.e. pull data therefrom. User-specific account settings stored in the remote entity 232 may define what user/mobile device-related information is visible to further entities 228 and what is not. Likewise, one or more other mobile devices 238 may be functionally connected to the network 230 for obtaining social contact and/or virtual context information relative to the device 102, e.g. from the server 232, and for providing corresponding local data in return. Alternatively, the mobile devices 102, 238 may communicate without a specific server/service 232 and address data directly to each other (based on e.g. social contact information), whereupon the devices 102, 238 may communicated without or via intermediate entities, such as network infrastructure entities.

The software 206 of the mobile device 102 preferably implements at least the afore-explained virtual context detection 206a and notification 206b logics via a number of software routines and/or software modules comprising the required instructions stored by one or more memory elements and executed by one or more processing devices in order to realize the desired functionalities, for example. In addition to or instead of software to be run on a more generic processing device, e.g. ASICs (application-specific integrated circuit) or programmable logic chips may be used to implement the corresponding functionalities. The aforesaid entities may co-operate with the short-range transceiver, such as an NFC transceiver, and the wireless transceiver.

The software 458, i.e. one or more applications, is executed in the server arrangement of the present invention. The software implements the afore-explained virtual context acquisition 458a and virtual environment management 458b logics (illustrated outside the server rectangle for clarity reasons) via a number of devices, software routines and/or software modules comprising the required instructions stored by one or more memory elements and executed by one or more processing devices in order to realize the desired functionalities, for example. In addition to or instead of software to be run on a more generic processing device, ASICs or programmable logic chips etc. may be used to implement the corresponding functionalities. The aforesaid entities may co-operate with the communications interface 454, such as a LAN (Local Area Network, e.g. Ethernet) network adapter.

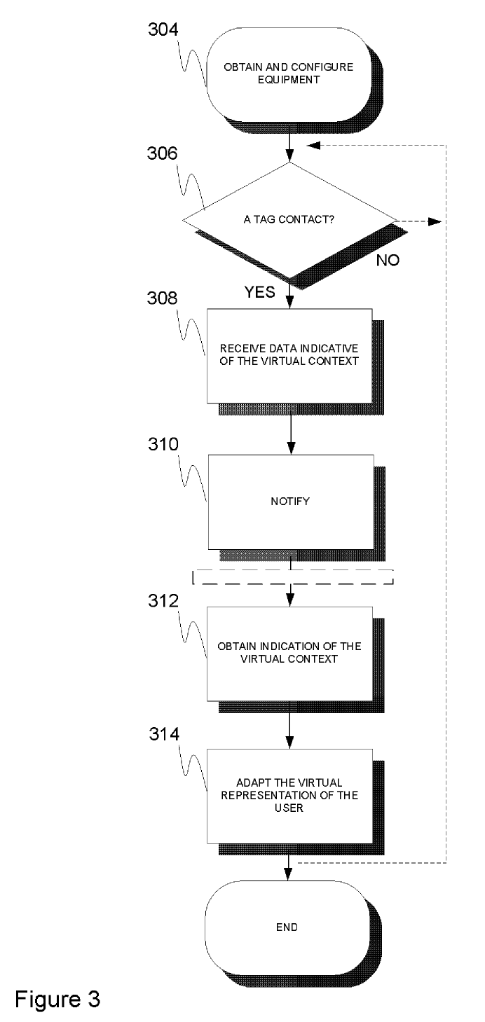

FIG. 3 is a flow diagram of an embodiment of a method according to the present invention. Upon start-up, at 304 initial actions enabling the execution of the further method steps are performed, i.e. equipment such as a mobile device that supports short-range communication may be provided with the necessary software. A number of tags may be obtained and configured, i.e. programmed and positioned as pondered hereinbefore. Yet, remote entities such as one or more servers and optional further entities may be configured and loaded with necessary additional software. At 306, upon a detected tag contact 306, data indicative of the virtual context is transmitted by the tag and received 308 by the mobile device. The mobile device may optionally cultivate the received implicit context data into proper virtual context information by a mapping logic, for instance. The mobile device notifies a remote entity such as a server of the virtual context by transmitting an indication thereof 310. The indication is obtained by the remote entity at 312 and used for adapting 314 (changing location, for instance) the virtual representation of the user of the mobile device in a virtual environment accordingly. The remote entity may locally host the virtual environment or provide instructions to a further remote entity hosting the environment. A rectangle drawn using a broken line highlights the possible existence of intermediate entities, such as servers, on a transmission path between the mobile device and the entity hosting the virtual environment or at least providing adaptation instructions thereto. A loop-back arrow illustrates the potentially repetitive nature of the overall method, i.e. the steps may be executed upon each instance of virtual context-related data reception from a tag.

The scope of the invention can be found in the following claims. Notwithstanding the various embodiments described hereinbefore in detail, a person skilled in the art will understand that different modifications may be introduced to the explicitly disclosed solutions without diverging from the fulcrum of the present invention as set forth in this text and defined by the independent claims.

1. A mobile communications device (102, 202) comprising a processor (220) and memory (222) for processing and storing data, respectively, a wireless transceiver (224b) for wirelessly transmitting and receiving data relative to remote devices (130, 230), a short-range wireless transceiver (224a), such as an NFC (near field communication) transceiver, for wirelessly co-operating with a remote device equipped with a compatible short-range transmitter or transceiver, such as a tag (104, 204), the mobile communications device further comprising
a virtual context detection logic (206a) configured to obtain, via the short-range wireless transceiver (224a), data distinctive to and provided by a tag disposed in a location accessible by a user of the mobile communications device in the light of the range of short-range data transfer, said distinctive data being indicative of the virtual context, and
a virtual context notification logic (206b) configured to transmit an indication of the virtual context, such as at least part of said obtained data, to a remote entity (232), such as a server or some other mobile communications device, via the wireless transceiver (224b) so as to enable the remote entity, or a further entity connected thereto, to represent the user in a virtual environment according to the virtual context.

2. The mobile communications device of claim 1, wherein the virtual context refers to a virtual space or location in the virtual environment whereto the virtual representation of the user is to be positioned.

3. The mobile communications device of claim 1, further configured to transmit status information related to the user of the device to the remote entity.

4. The mobile communications device of claim 1, comprising a mapping logic for mapping data indicative of the virtual context as provided by the tag to a virtual context for transmitting the indication thereof.

5. The mobile communications device of claim 1, comprising a UI (user interface) for facilitating registration to a virtual environment and/or social networking service by visually representing both a number of services and an indication of the user, whereupon an action by the user, such as a drag-and-drop action, mating the indication of the user with a representation of a certain service at least initiates the registration to the certain service.

6. A server arrangement (132, 232, 234, 228) for controlling a virtual environment, such as a virtual hangout system of a number of users, comprises a processor (450) for processing data, a memory (452) for storing data, and a communications interface (454) for transferring data via a communications network, the server arrangement further comprising
a virtual context acquisition logic (458a) for obtaining, via the communications interface, a virtual context indication relative to a user of the virtual environment, said indication being based on data distinctive to and provided by a tag disposed in a location accessible by the user with a short-range wireless transceiver of a mobile communications device, said distinctive data being indicative of the virtual context associated with the tag, and
a virtual environment management logic (458b) for adapting the virtual representation of the user, such as an avatar, according to the virtual context in the virtual environment.

7. The server arrangement of claim 6, wherein the virtual context refers to a virtual space or location in the virtual environment whereto the representation of the user is positioned during said adapting.

8. The server arrangement of claim 6, configured to obtain status information related to the user and to adapt the virtual representation of the user accordingly.

9. The server arrangement of claim 6, comprising a service toolbox for a service provider, such as an event organizer, said toolbox enabling obtaining information related to a number of users having communicated with at least one tag associated with the service via their mobile communications devices.

10. The server arrangement of claim 6, providing a UI (user interface) for a user, configured to facilitate registration to a virtual environment and/or social networking service by visually representing both the service and an indication of the user, whereupon an action by the user, such as a drag-and-drop action, mating the indication of the user with the representation of the service at least initiates registration to the service.

11. A method for enhancing context awareness in applications incorporating a virtual environment feature, comprising
obtaining indication of a virtual context of a user of a mobile communications device (312), said indication being based on data provided by a short-range wireless communications tag to the mobile communications device, and
adapting a virtual representation of the user in the virtual environment according to the virtual context (314).

12. The method of claim 12, wherein the virtual context to a virtual space or location in the virtual environment whereto the representation of the user is positioned during said adapting.

13. A computer program, comprising code means adapted, when run on a computer device, to execute the method steps of claim 11.

14. A carrier medium comprising the computer program of claim 13.

15. The mobile communications device of claim 2, further configured to transmit status information related to the user of the device to the remote entity.

16. The server arrangement of claim 7, configured to obtain status information related to the user and to adapt the virtual representation of the user accordingly.
